(19) United States
(12) Patent Application Publication
(10) Pub. No.: US 2026/0312838 A1
(43) Pub. Date: Oct. 8, 2026

(54) SYSTEM AND METHOD OF OPERATING HOUSEHOLD APPLIANCES

(71) Applicant: Haier US Appliance Solutions, Inc., Wilmington, DE (US)

(72) Inventors: Chad Michael Helms, Louisville, KY (US); Todd Elliott Greenwood, Pewee Valley, KY (US)

(21) Appl. No.: 19/098,230

(22) Filed: Apr. 2, 2025

(51) Int. Cl. H04L 12/28

(52) U.S. Cl. CPC H04L 12/2823; H04L 12/2807; H04L 12/2816; H04L 12/2827; H04N 21/4131; G05B 2219/2642; H04L 12/46

(57) ABSTRACT

A method for operating a group of household appliances includes connecting each household appliance of the group to one local network of a plurality of local networks. Additionally, the method includes connecting each gateway of a group of gateways to one local network of the plurality of local networks. Furthermore, the method includes commissioning the group of gateways, the group of household appliances, and a group of sensors to a single account in a cloud computing network. Moreover, the method includes receiving, at a gateway of the group, an input indicative of a household appliance triggering event from a sensor of the group of sensors. Additionally, the method includes identifying a household appliance of the group connected to the one local network to which the gateway is connected. Furthermore, the method includes adjusting an operation of the identified household appliance based on the received input indicative of the triggering event.

### FIELD

The present subject matter relates generally to household appliances which connect to a home network and/or a remote network such as the Internet. In particular, the present subject matter relates to methods of operating multiple household appliances across multiple networks.

### BACKGROUND

Household appliances are utilized generally for a variety of tasks by a variety of users. For example, a household may include such appliances as laundry appliances, e.g., a washer and/or dryer, kitchen appliances, e.g., a refrigerator, a microwave, and/or a dishwasher, along with room air conditioners and other various appliances.

Some household appliances may also include features for connecting to and communicating over a secure wireless network. Such communication may provide connected features on the household appliances, e.g., where the household appliance communicates with a personal device, smart home systems, and/or a remote computing device such as a cloud server or database. Such communication may also provide the ability to monitor and control the operation of household appliances connected to a particular local network that are connected to a user account.

Some consumers may have multiple local networks, e.g., each local network being associated with a different residence or home. Household appliances across multiple local networks may all be connected to the same user account. However, users may desire to monitor and control the operation of household appliances in one local network without affecting the operation of household appliances under the same user account that are in different local networks.

Accordingly, a system and a method that permit monitoring and control of household appliances across multiple local networks would be beneficial.

### BRIEF DESCRIPTION

Aspects and advantages of the invention will be set forth in part in the following description, or may be obvious from the description, or may be learned through practice of the invention.

In accordance with one exemplary embodiment of the present disclosure, a method of operating a group of household appliances is provided. The method includes connecting each household appliance of the group of household appliances to one local network of a plurality of local networks. Additionally, the method includes connecting each gateway device of a group of gateway devices to one local network of the plurality of local networks. Furthermore, the method includes commissioning the group of gateway devices, the group of household appliances, and a group of sensors to a single account in a cloud computing network. Moreover, the method includes receiving, at a gateway device of the group of gateway devices, an input indicative of a household appliance triggering event from a sensor of the group of sensors. Additionally, the method includes identifying a household appliance of the group of household appliances connected to the one local network of the plurality of local networks to which the gateway device is connected. Furthermore, the method includes adjusting an operation of the identified household appliance based on the received input indicative of the household appliance triggering event.

In accordance with another exemplary embodiment of the present disclosure, a system is provided. The system includes a sensor. The sensor is configured to provide an input indicative of a household appliance triggering event. Additionally, the system includes a gateway device. The gateway device is configured to receive the input provided by the sensor. Furthermore, the system includes a household appliance. Moreover, the system includes a remote computing device of a cloud computing network. The remote computing device is connected to the gateway device and the household appliance. Additionally, the remote computing device is configured to receive a first input from the gateway device that the gateway device has received the input provided by the sensor indicative of the household appliance triggering event. Furthermore, the remote computing device is configured to receive a second input from the gateway device identifying the household appliance from a group of household appliances. The household appliance is connected to a local network of a plurality of local networks to which the gateway device is connected. Moreover, the remote computing device is configured to adjust an operation of the household appliance based on the received first input and the received second input.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary laundry appliances in accordance with one or more exemplary embodiments of the present disclosure.

FIG. 2 provides a side cross-sectional view of one of the exemplary laundry appliances of FIG. 1.

FIG. 3 provides a perspective view of the other exemplary laundry appliance of FIG. 1 with portions of a cabinet of the laundry appliance removed to reveal certain components of the laundry appliance.

FIG. 4 provides a front view of an exemplary group of kitchen appliances in accordance with one or more additional exemplary embodiments of the present disclosure.

FIG. 5 provides a side schematic view of the group of kitchen appliances of FIG. 4.

FIG. 6 provides a diagrammatic illustration of multiple household appliances in accordance with one or more additional exemplary embodiments of the present disclosure.

FIG. 7 provides a flowchart illustrating an example method of operating household appliances according to one or more example embodiments of the present disclosure.

The use of the same reference numbers in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

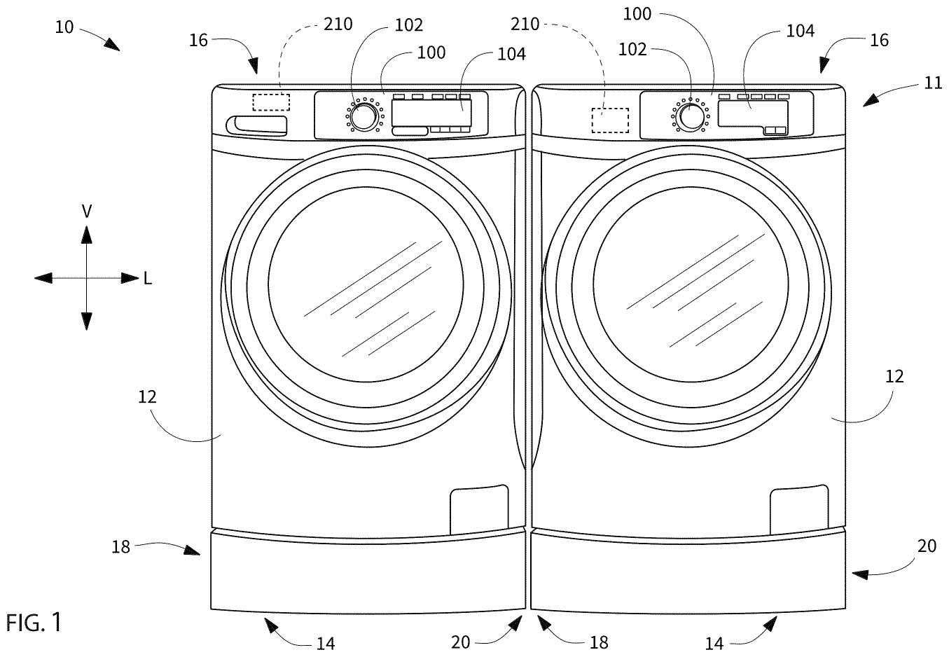

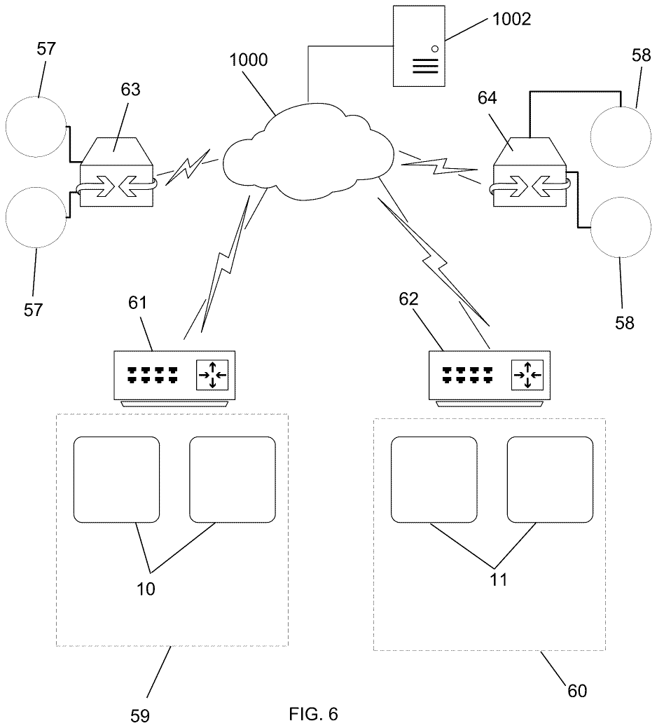

As may be seen in FIGS. 1 through 5, in accordance with one or more embodiments of the present subject matter, a group of household appliances, which may include a first household appliance 10 and a second household appliance 11, are provided. The illustrated groups of two appliances are provided by way of example only. Various embodiments of the present subject matter may also include three or more appliances (see, for example, FIG. 6). For example, the exemplary appliances of FIGS. 1 through 5 may each be provided in various combinations with one or more of the other appliances of FIGS. 1 through 5 and/or either or both groups of appliances illustrated in FIGS. 1 through 5. Each appliance of the group or two or more appliances disclosed herein may be operable and configured to connect to one or more remote computing devices, e.g., a cloud or other distributed computing environment, as will be described in more detail below.

As generally seen throughout FIGS. 1 through 5, each household appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

Each household appliance 10 and 11 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be the user input device 102.

Generally, each household appliance 10 and 11 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the household appliances 10 and 11. Operation of the household appliances 10 and 11 may each be regulated by the respective controller 210 that is operatively coupled to the corresponding user interface panel 100. A user interface panel 100 may, for example, provide selections for user manipulation of the operation of an appliance, e.g., via user input device 102 and/or display component 104. In response to user manipulation of the user interface panel 100 and/or user input device 102, the controller 210 may operate various components of the household appliance 10 or 11. Each controller 210 may include a memory and one or more microprocessors, CPUs or the like, such as general or special purpose microprocessors operable to execute programming instructions or micro-control code associated with operation of the household appliance 10 or 11. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective household appliance 10 or 11 by executing instructions stored in memory. For example, the instructions may be software or any set of instructions that when executed by the processing device, cause the processing device to perform operations. Controller 210 may include one or more processor(s) and associated memory device(s) configured to perform a variety of computer-implemented functions and/or instructions (e.g. performing the methods, calculations and the like and storing relevant data as disclosed herein). It should be noted that controllers 210 as disclosed herein are capable of and may be operable to perform any methods or associated method steps as disclosed herein.

In some embodiments, for example, as illustrated in FIG. 1, the group of household appliances 10 and 11 may be or include a pair of laundry appliances. In the exemplary embodiment illustrated in FIG. 1, the first appliance may be a washing machine appliance 10 and the second appliance may be a dryer appliance 11. In embodiments such as illustrated in FIG. 1, the user input device 102 of each household appliance 10 and 11 may be positioned on the user interface panel 100. The embodiment illustrated in FIG. 1 also includes a display component 104 on the user interface panel 100 of each household appliance 10 and 11.

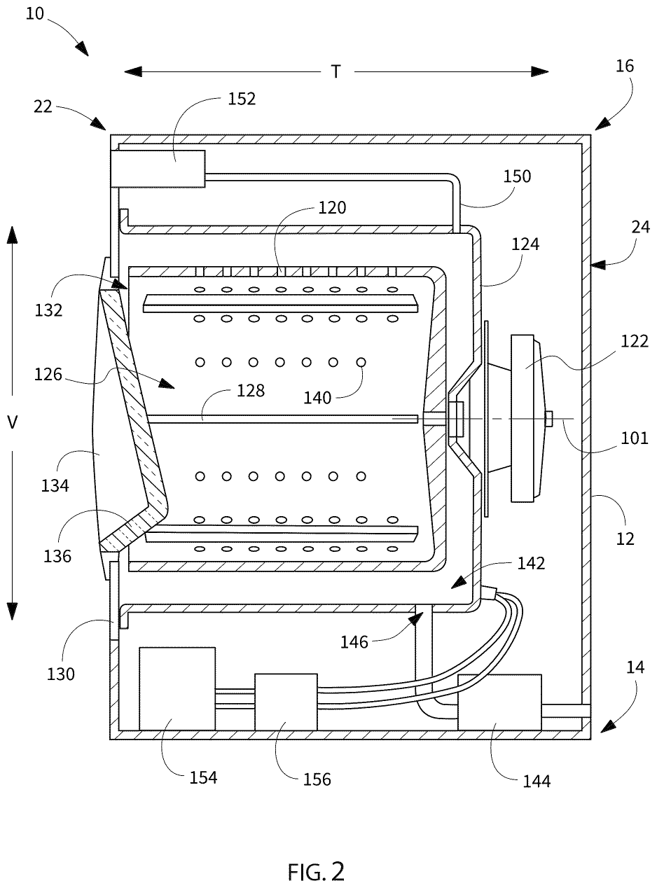

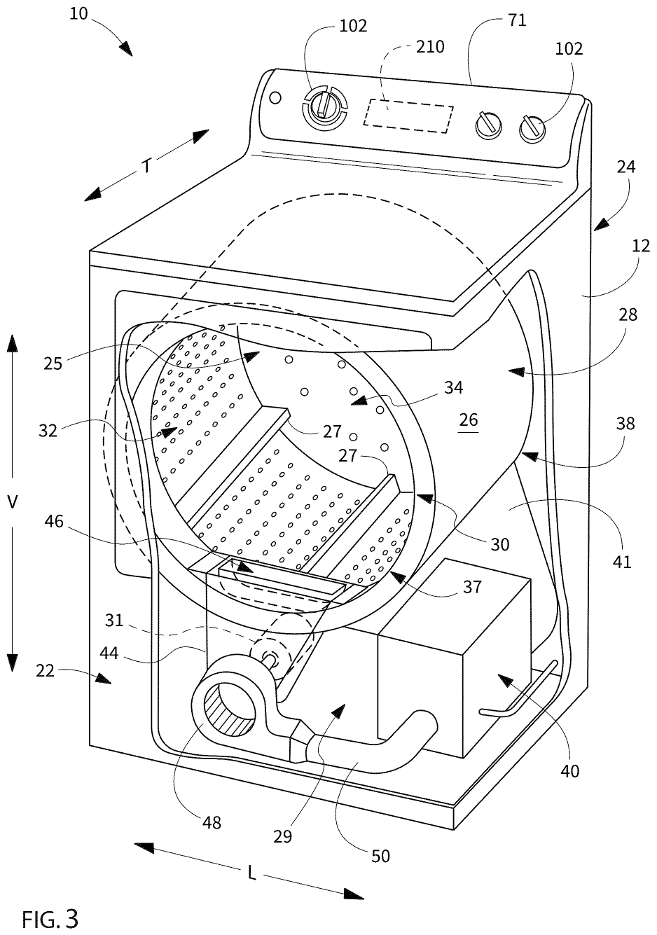

Additional exemplary details of the laundry appliances 10 and 11 are illustrated in FIGS. 2 and 3. For example, FIG. 2 provides a cross-sectional view of an exemplary washing machine appliance 10 which may, in various embodiments, be one appliance of a group of connected appliances. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the wash tub 124 such that the wash basket 120 is rotatable about an axis of rotation, which generally coincides with central axis 101 of the wash tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the wash tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from wash basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of wash basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from wash basket 120 to sump 142 through plurality of perforations 140. A pump assembly 144 is located beneath wash tub 124 for gravity assisted flow when draining wash tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a dispenser drawer 152 is slidably mounted within front panel 130. Dispenser drawer 152 receives a wash additive (e.g., detergent, fabric softener, bleach, or any other suitable liquid or powder) and directs the fluid additive to wash tub 124 during operation of washing machine appliance 10. According to the illustrated embodiment, dispenser drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user may fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation may be initiated through operator manipulation of selector inputs 102. Wash tub 124 is filled with water, detergent, and/or other fluid additives, e.g., via spout 150 and/or dispenser drawer 152. One or more valves (not shown) may be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 may be agitated (e.g., with ribs 128) for washing of laundry items in wash basket 120.

After the agitation phase of the wash cycle is completed, wash tub 124 may be drained. Laundry articles may then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, wash basket 120 is rotated at relatively high speeds. After articles disposed in wash basket 120 are cleaned and/or washed, the user may remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1 with a portion of a cabinet 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a back side 24 spaced apart from each other along the transverse direction T. Within cabinet 12, an interior volume 29 is defined. A drum 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or heating system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 may be fixed or may be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by supply duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on a cabinet 12 (e.g., on a backsplash 71) and are in operable communication (e.g., electrically coupled) with the processing device or controller 210. Controller 210 may also be provided in operable communication with components of the dryer appliance 11 including motor 31, blower fan 48, or heating system 40. In turn, signals generated in controller 210 direct operation of motor 31, blower fan 48, or heating system 40 in response to the position of selector inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 210 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

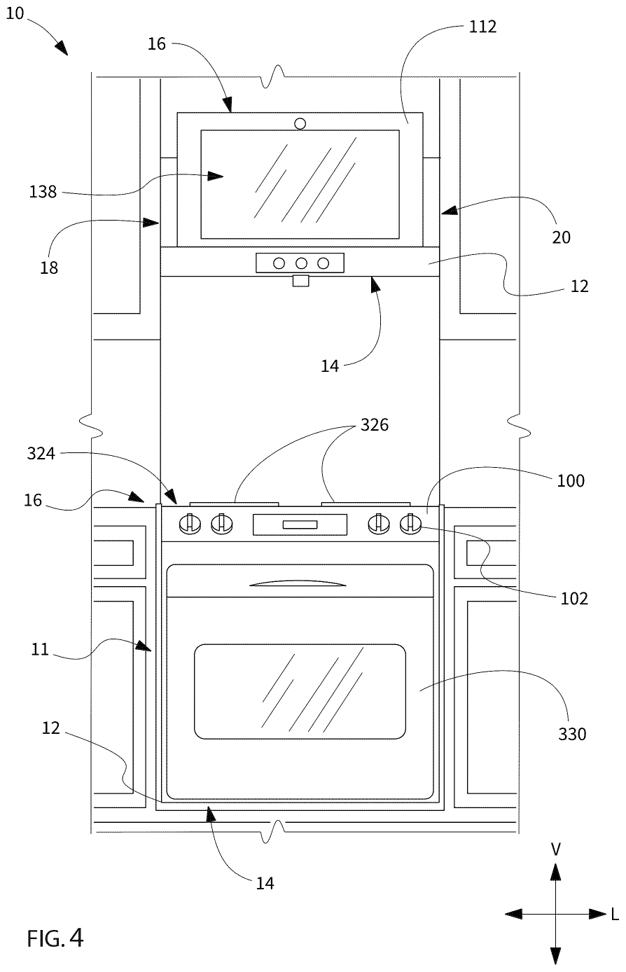

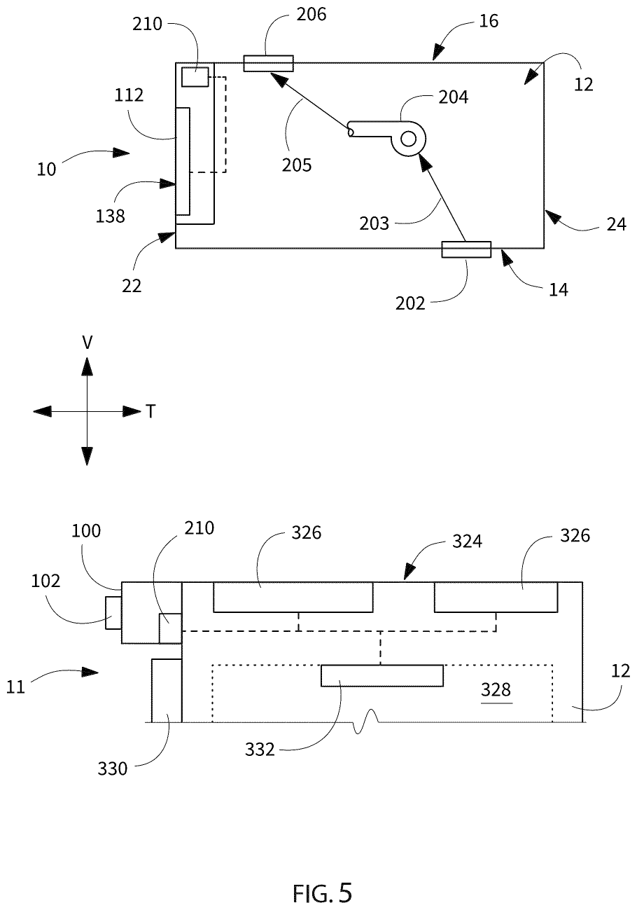

FIGS. 4 and 5 illustrate another example embodiment of a group of household appliances where the first household appliance 10 and the second household appliance 11 are kitchen appliances. In the exemplary embodiment illustrated in FIGS. 4 and 5, the first household appliance 10 is a user engagement system which includes an image monitor 112 that is generally positioned above a cooktop appliance 11, e.g., along the vertical direction V. Image monitor 112 may include a touchscreen capable of receiving a user input by detecting and responding to a touch on a surface of the image monitor 112.

Referring again to FIGS. 4 and 5, cooktop appliance 11 includes a chassis or cabinet 12 that extends along the vertical direction V between a top side 16 and a bottom side 14. Cooktop appliance 11 may include a cooktop surface 324 having one or more heating elements 326 for use in, for example, heating or cooking operations. In one example embodiment, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In various embodiments, the heating elements 326 may include one or more of a gas burner element, resistive heat element, radiant heat element, induction element, or another suitable heating element.

In some embodiments, the cabinet 12 of the cooktop appliance 11 may be insulated and may define a cooking chamber 328 selectively enclosed by a door 330. One or more heating elements 332 (e.g., top broiling elements or bottom baking elements) may be positioned within cabinet 12 of cooktop appliance 11 to heat cooking chamber 328. Heating elements 332 within cooking chamber 328 may be provided as any suitable element for cooking the contents of cooking chamber 328, such as an electric resistive heating element, a gas burner, a microwave element, a halogen element, etc. Thus, cooktop appliance 11 may be referred to as an oven range appliance. As will be understood by those skilled in the art, cooktop appliance 11 is provided by way of example only, and the present subject matter may be used in the context of any suitable cooking appliance, such as a double oven range appliance or a standalone cooktop (e.g., fitted integrally with a surface of a kitchen counter). Thus, the example embodiments illustrated and described are not intended to limit the present subject matter to any particular cooking chamber or heating element configuration, unless explicitly indicated as being limited.

As illustrated, a user interface panel 100 may be provided on cooktop appliance 11. Although shown at the front portion of cooktop appliance 11, another suitable location or structure (e.g., a backsplash) for supporting user interface panel 100 may be provided in alternative embodiments. In some embodiments, user interface panel 100 includes input components or controls 102, such as one or more of a variety of electrical, mechanical, or electro-mechanical input devices. Controls 102 may include, for example, rotary dials, knobs, push buttons, and touch pads. A controller 210 is in communication with user interface panel 100 and controls 102 through which a user may select various operational features and modes and monitor progress of cooktop appliance 11. In additional or alternative embodiments, user interface panel 100 includes a display component, such as a digital or analog display in communication with a controller 210 and configured to provide operational feedback to a user. In certain embodiments, user interface panel 100 represents a general purpose I/O (“GPIO”) device or functional block.

As shown, controller 210 is communicatively coupled (i.e., in operative communication) with user interface panel 100 and its controls 102. Controller 210 may also be communicatively coupled with various operational components of cooktop appliance 300 as well, such as heating elements (e.g., 326, 332), sensors, and the like. Input/output (“I/O”) signals may be routed between controller 210 and the various operational components of cooktop appliance 11. Thus, controller 210 may selectively activate and operate these various components. Various components of cooktop appliance 11 are communicatively coupled with controller 210 via one or more communication lines such as, for example, conductive signal lines, shared communication busses, or wireless communications bands.

As shown in FIGS. 4 and 5, the first household appliance 10 is, by way of example, a user engagement system, which is an example embodiment of a household appliance and which may be one of a group of household appliances, such as the first household appliance. In such embodiments, the first household appliance 10 may include one or more casings (e.g., a hood casing) provided above cooktop appliance 11 along the vertical direction V. For example, a hood casing 12 may be positioned above cooktop appliance 11. Hood casing 12 includes a plurality of outer walls and generally extends along the vertical direction V between a top side 16 and a bottom side 14, along the lateral direction L between a left side 18 and a right side 20, e.g., “right” and “left” as used herein refer to from a perspective of a user standing in front of the first household appliance 10. As shown in FIG. 5, the hood casing 12 may also extend along the transverse direction T between a front side 22 and a back side 24. In some embodiments, hood casing 12 is spaced apart from cooktop surface 324 along the vertical direction V such that an open region is defined therebetween.

As shown in FIG. 5, in kitchen appliance embodiments, one of the household appliances 10 and 11 may be or include a ventilation assembly within hood casing 12 which is configured to direct an airflow from the open region between the household appliances 10 and 11 and through hood casing 12 of the upper appliance, e.g., which is indicated as first household appliance 10 in the example illustrations of FIGS. 4 and 5, but which may instead be the second household appliance 11, e.g., when the cooktop appliance is the first household appliance 10. Other configurations may be used within the spirit and scope of the present disclosure. For example, although a generally rectangular shape is illustrated, any suitable shape or style may be adapted to form the structure of hood casing 12.

In some embodiments, an image monitor 112 may be provided above cooktop surface 324 (e.g., along the vertical direction V). For instance, image monitor 112 may be mounted to or supported on hood casing 12 of the first household appliance 10 (e.g., directly above cooktop surface 324) proximal to the front side 22. Generally, image monitor 112 may be any suitable type of mechanism for visually presenting a digital (e.g., interactive) image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically viewable picture (e.g., static image or dynamic video) to a user. Optionally, a protective transparent panel (e.g., formed from a transparent glass, plastic, etc.) may be positioned across or over imaging surface 138. In some such embodiments, the protective transparent panel is mounted within or supported on hood casing 12 forward from imaging surface 138 along the transverse direction T.

As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of the first household appliance 10 or cooktop appliance 11. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel), sensors overlaid across imaging surface 138, or any other suitable input.

As illustrated, the imaging surface 138 is directed toward the area forward from the cooktop appliance 11. During use, a user standing in front of cooktop appliance 11 may thus see the optically viewable picture (e.g., recipe, dynamic video stream, graphical user interface, etc.) displayed at the imaging surface 138.

As mentioned, in embodiments where the first household appliance 10 is the user engagement system, the first appliance may be or include a ventilation assembly. In such embodiments, one or more air outlets 206 may be defined by hood casing 12 (e.g., through one or more external walls of hood casing 12). As shown for example in FIG. 5, air outlet 206 defined through hood casing 12 may be defined through hood casing 12 at the top side 16. The ventilation system may generally extend between one or more air inlets 202 defined in the bottom side 14 of the hood casing 12 and air outlet 206. For example, the bottom side 14 of the hood casing 12 of the first household appliance 10 may face the cooktop surface 324 of the cooktop appliance 11. The ventilation system may also include an air handler 204 fixedly mounted within the hood casing 12 in fluid communication with the air inlet 202 to motivate an intake flow of air 203 through the air inlet 202 to the air handler 204 and an exhaust flow of air 205 from the air handler 204 to the air outlet 206.

As will be understood, air handler 204 may be provided as any suitable blower or fan (e.g., radial fan, tangential fan, etc.) positioned within hood casing 12 to actively rotate or motivate air, steam, or vapors 203 into and through air inlet 202. Optionally, one or more filters (not pictured) may be provided at air inlet 202 to clean the air, steam, or vapors 203 as it enters hood casing 12 from the open region between the household appliances 10 and 11. For instance, a grease filter having a suitable coarse filter medium, such as a metallic mesh including aluminum or stainless steel, may be mounted across air inlet 202. Additionally, or alternatively, an odor filter having a suitable fine filter medium, such as a mesh or block including activated carbon, may be mounted across air inlet 202. Optionally, the odor filter may be positioned above or downstream from the grease filter.

According to various embodiments of the present disclosure, the group of household appliances 10 and 11 may take the form of any of the examples described above in various combinations of any two or more of the exemplary household appliances described above or may be any other household appliance. Thus, it will be understood that the present subject matter is not limited to any particular household appliance.

Further, all appliances, e.g., household appliances 10 and 11, of the group of household appliances need not necessarily be related or located in the same room or even the same building as one another. For instance, while the household appliances 10 and 11 are both laundry appliances in the example illustrated in FIG. 1 and are both kitchen appliances in the example illustrated in FIG. 4, the group of household appliances may include any two or more appliances which are registered/connected to the same user account in a cloud computing network. In this respect, the group of household appliances may be connected to the same remote computing device, such as a cloud server or database. Thus, in just one possible example, the first household appliance 10 could be a refrigerator appliance, and the second household appliance 11 could be any of the other example appliances described herein, such as the washer and/or dryer of FIG. 1, as well as any one or more other household appliances. Additionally, one or more first household appliances 10 may belong to a first subgroup of household appliances 59 (FIG. 6) of the group of household appliances and one or more second household appliances 11 may belong to a second subgroup of household appliances 60 (FIG. 6) of the group of household appliances. Each subgroup of household appliances 59 and 60 may be connected to a different local network from each other. For example, the first subgroup of household appliances described above may be connected to a first local network and the second subgroup of household appliances may be connected to a second local network different from the first local network. The second local network may be at the same building, e.g., residential home, as the first local network or may be at a different building as the first local network. However, it should be appreciated that, while the first subgroup of household appliances 59 and the second subgroup of household appliances 60 may not be connected to the same local network, the first subgroup of household appliances 59 and the second subgroup of household appliances 60 belong to the same group of household appliances, which are all connected to the same user account. Additionally, it should be appreciated that, while described herein as including a first subgroup of household appliances 59 and a second subgroup of household appliances 60, the group of household appliances may include any suitable number of subgroups of household appliances, such as greater than two subgroups of household appliances.

It should be understood that “household appliances” and/or “appliances” are used herein to describe appliances typically used or intended for common domestic tasks, such as laundry appliances or kitchen appliances, e.g., as illustrated in FIGS. 1 through 5, or air conditioners, dishwashing appliances, water heaters, etc., and any other household appliance which performs similar functions in addition to network communication and data processing. Accordingly, it will be recognized that the domestic task(s) which the appliance is configured to perform includes operating on tangible matter (e.g., water, air, food items, laundry articles, and/or other such matter) to change a physical attribute (e.g., temperature, pressure, position, velocity, etc.) of the tangible matter using a mechanical component of the appliance. Thus, devices such as personal computers, routers, and other similar devices whose primary functions are network communication and/or data processing are not considered household appliances as used herein.

As used herein, the term “household” or “residence” includes a domestic structure or dwelling place in which one or more people eat, sleep, and/or spend leisure time. For example, a household (e.g., within which the group of household appliances is located and used) may be a dormitory, condo unit, apartment unit, townhome, single-family home, or other similar places.

Turning now to FIG. 6, an exemplary group of household appliances including multiple household appliances 10 and 11 are illustrated. The household appliances 10 and 11 may be any suitable household appliances, such as the household appliances described above. Specifically, a first subgroup of household appliances 59 of the group of household appliances and a second subgroup of household appliances 60 of the group of household appliances are illustrated. The first subgroup of household appliances 59 may include multiple first household appliances 10 and second subgroup of household appliances 60 may include multiple second household appliances 11. As briefly described above, the subgroups of the group of household appliances may be connected to different local networks. For example, the first subgroup of household appliances 59 may be connected to a first local network, e.g., wirelessly through a first router 61, and the second subgroup may be connected to a second local network, e.g., wirelessly through a second router 62. Furthermore, the group of household appliances may be part of and connected to the same user account. In this respect, the group of household appliances may be connected to the same remote computing device 1002, e.g., a remote server, remote database, and/or other such computing devices, e.g., of a cloud computing network/in the cloud 1000. Thus, a user with multiple local networks, such as one local network with one subgroup of connected household appliances at a primary residence and a different local network with a different subgroup of connected household appliances at a vacation residence, may remotely monitor and/or control the operation of all household appliances of the group of household appliances across all local networks.

FIG. 6 schematically illustrates the first subgroup of household appliances 59 and the second subgroup of household appliances 60, which may include household appliances 10 and 11, in communication, e.g., wireless communication as illustrated in FIG. 6, with a remote computing device 1002 in a distributed computing environment, such as cloud 1000. For example, the household appliances 10 and 11 of the first subgroup of household appliances 59 and the second subgroup of household appliances 60 and, in particular, the controllers 210 thereof, may be connected to respective first and second local networks, e.g., by first router 61 and second router 62 respectively. The first router 61 and the second router 62 of the first local network and the second local network respectively, may be connected to a remote computing device 1002 such as remote computer, server, and/or database, in the cloud 1000. As such, the household appliances 10 and 11 of the first subgroup of household appliances 59 and the second subgroup of household appliances 60 may be in communication with the remote computing device 1002.

Furthermore, a group of gateway devices, such as a first gateway device 63 and a second gateway device 64, may be associated with the first and second local networks respectively and connected to the user account. As will be described below, the first gateway device 63 may collect data or inputs, such as sensor data and/or a list of household appliances that are connected to the first local network. Likewise, as will be described below, the second gateway device 64 may collect data or inputs, such as sensor data and/or a list of household appliances that are connected to the second local network. Additionally, the first gateway device 63 and the second gateway device 64 may be in communication with the remote computing device 1002 in the cloud 1000. As such, the first gateway device 63 and the second gateway device may transmit or forward received data/inputs to the remote computing device 1002. The gateway devices 63 and 64 may be any suitable gateway devices, such as routers, modems, security gateways, VoIP gateways, bridges, access points (AP), or the like. Additionally, in some embodiments, the first gateway device 63 and/or the second gateway device 64 may be standalone gateway devices, e.g., separate from the household appliances of the first subgroup of household appliances 59 and the second subgroup of household appliances 60 respectively. For example, first gateway device 63 and/or second gateway device 64 may receive electrical power independently from household appliances, e.g., may be directly connected to a receptacle. However, it should be appreciated that, in some other embodiments, the first gateway device 63 may be part of one of the first household appliances 10, e.g., electrically integrated with the circuitry the first household appliance 10, and/or the second gateway device 64 may be part of one of the second household appliances 11, e.g., electrically integrated with the circuitry of the second household appliance 11. In this respect, the first gateway device 63 may receive electrical power from/through an electrical circuit of one of first household appliances 10 and/or the second gateway device 64 may receive electrical power from/through an electrical circuit of one of second household appliances 11.

As mentioned above, controllers 210 may be operable to perform any methods and associated method steps as disclosed herein. Additionally, or alternatively, gateway devices 63 and/or 64 and/or the remote computing device 1002 of the cloud 1000 may be operable to perform any methods and associated method steps disclosed herein. Additionally, performance of such methods and method steps may also be distributed, e.g., one or more steps of a method may be performed by the household appliances 10 and/or 11 (e.g., controllers 210 thereof), while one or more other steps of the same method may be performed by one or more different devices, such as the remote computing device 1002 (e.g., the cloud 1000) and/or the first gateway device 63 and/or the second gateway device 64.

Additionally, as illustrated in FIG. 6, one or more sensors or sensing devices may be provided in operative association with the group of household appliances. Specifically, multiple first sensors 57 may be provided in operative association with the first household appliances 10 of the first subgroup of household appliances 59. Additionally, multiple second sensors 58 may be provided in operative association with the second household appliances 11 of the second subgroup of household appliances 60. In some embodiments, the first sensors 57 and/or the second sensors 58 may be safety sensors configured to detect household appliance triggering events associated with safety. For example, the first sensors 57 and/or second sensors 58 may include a water leak sensing device positioned externally of one or more of household appliances 10 and/or 11, e.g., washing machine appliance, of the first subgroup of household appliances 59 for detecting an external water leak of the first household appliance(s) 10. Additionally, or alternatively, the first sensors 57 and/or second sensors 58 may include a smoke detector positioned externally of and above the household appliances 10 and/or 11, e.g., dryer appliance, cooktop appliance, and/or the like, for detecting a presence of smoke emanating from one or more of the household appliances 10 or 11. However, it should be appreciated that the safety sensors may include any suitable type of safety sensor/sensing devices in addition to or other than water leak sensing devices and smoke detectors, such as safety sensors that detect matter emanating from one or more of the household appliances 10 or 11. Additionally, or alternatively, it should also be appreciated that first sensors 57 and/or second sensors 58 may include any other suitable type of sensor or sensing device other than a safety sensor. For example, the first sensors 57 and/or second sensors 58 may include detection sensors configured to detect a presence of a human/user, animal, and/or the like.

In some exemplary embodiments, the first sensors 57 may be operatively or communicatively coupled to the first gateway device 63. Likewise, the second sensors 58 may be operatively or communicatively coupled to the second gateway device 64. In this respect, the first gateway device 63 may receive signals or data from first sensors 57 indicative of one or more household appliance triggering events of any of the first household appliances 10 of the first subgroup of household appliances 59, such as water leaking from and/or smoke emanating from one or more of the first household appliances 10, the presence of a user at any of the first household appliances 10, and/or the like. Likewise, the second gateway device 64 may receive signals or data from second sensors 58 indicative of one or more household appliance triggering events of any of the second household appliances 11 of the second subgroup of household appliances 60, such water leaking from and/or smoke emanating from one or more of first household appliances 10, the presence of a user at any of the second household appliances 11, and/or the like.

Additionally, or alternatively, in some embodiments, the first sensors 57 may be operatively or communicatively coupled to the controllers 210 of one or more of the first household appliances 10 of the first subgroup of household appliances 59. Additionally, or alternatively, the second sensors 58 may be operatively or communicatively coupled to the controllers 210 of one or more of the second household appliances 11 in the second subgroup of household appliances 60. In this respect, the controllers 210 of one or more of the first household appliances 10 may receive signals or data from first sensors 57 indicative of one or more household appliance triggering events of any of the first household appliances 10 of the first subgroup of household appliances 59, such water leaking from and/or smoke emanating from one or more of the first household appliances 10, the presence of a user at any of the first household appliances 10, and/or the like. Likewise, the controllers 210 of one or more of the second household appliances 11 may receive signals or data from second sensors 58 indicative of one or more household appliance triggering events of any of the second household appliances 11 of the second subgroup of household appliances 60, such water leaking from and/or smoke emanating from one or more of first household appliances 10, the presence of a user at any of the second household appliances 11, and/or the like.

In some embodiments, first sensors 57 and/or second sensors 58 may be a short-range BLUETOOTH® sensing device(s) connectable to one or more of the first gateway device 63 and the second gateway device 64 respectively, the controllers 210, and/or any other suitable device. The short-range BLUETOOTH® sensing device(s) may transmit communications using BLUETOOTH®. However, it should be appreciated that first sensors 57 and/or second sensors 58 may be any other suitable sensing device(s) and transmit communications in any suitable manner, such as via WI-FI®, ZIGBEE®, wireless radio, laser, infrared, Ethernet, etc. In some exemplary embodiments, the first sensors 57 may be connected to the first gateway device 63 by a wireless, non-WIFI® connection, e.g., BLUETOOTH®, and the second sensors 58 may be connected to the second gateway device 64 by a wireless, non-WIFI® connection, e.g., BLUETOOTH®.

As used herein, “short-range” may include ranges less than about ten meters and up to about one hundred meters. For example, a wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may provide short-range wireless communication between the first sensors 57 and the first household appliances 10 and/or between the second sensors 58 and the second household appliances 11. For example, BLUETOOTH® Low Energy may minimize the power consumed by the exemplary methods and devices described herein due to the low power networking protocol of BLUETOOTH® Low Energy.

In some embodiments, the performance of exemplary methods and associated method steps may be distributed, e.g., performed in part by the controller 210 of the household appliances 10 and/or 11, and in part by one or more remote computing devices 1002 in the cloud 1000 and/or by the gateway devices 63 and/or 64. For example, data, which may include identifying information for the household appliances 10 and 11 may be transmitted from the gateway devices 63 and/or 64 to the cloud 1000. The data may be analyzed or processed, e.g., in the cloud 1000, in embodiments which include distributed computing as described above.

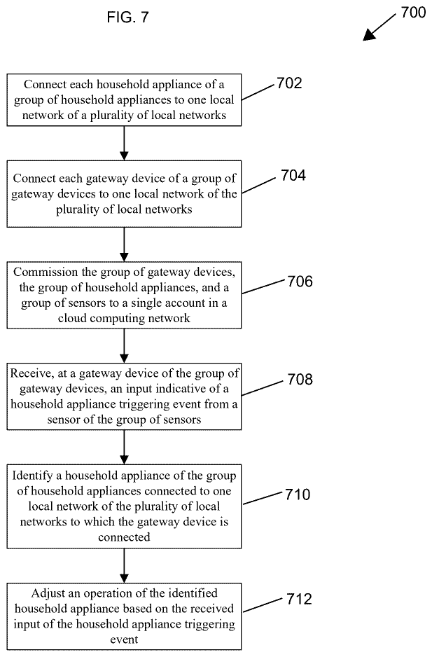

Turning now to FIG. 7, steps performed in a particular order for purposes of illustration and discussion are depicted. Those of ordinary skill in the art, using the disclosures provided herein, will understand that the steps of the method 700 can be modified, adapted, rearranged, omitted, interchanged, or expanded in various ways without deviating from the scope of the present disclosure.

As shown in FIG. 7, the method 700 includes connecting each household appliance of a group of household appliances to one local network of a plurality of local networks, e.g., as indicated at (702) in FIG. 7. Specifically, each household appliance of the group of household appliances, which may include each household appliance of the first subgroup of household appliances 59, e.g., each of first household appliances 10, and each of the second subgroup of household appliances 60, e.g., each of second household appliances 11, may be connected, e.g., wirelessly, to one of the local networks of the plurality of local networks. However, each first household appliance 10 of the first subgroup of household appliances 59 may be connected to a different local network than each second household appliance 11 of the second subgroup of household appliances 60. For example, each first household appliance 10 of the first subgroup of household appliances 59 may be connected to the first local network and each second household appliance 11 of the second subgroup of household appliances 60 may be connected to the second local network.

Furthermore, the method 700 includes connecting each gateway device of a group of gateway devices to one local network of the plurality of local networks, e.g., as indicated at (704) in FIG. 7. Specifically, each gateway device of the group of gateway devices, which may include first gateway device 63 and second gateway device 64, may be connected, e.g., wirelessly, to one local network of the plurality of local networks. However, the first gateway device 63 may be connected to a different local network than the second gateway device 64. For example, the first gateway device 63 may be connected to the first local network and the second gateway device 64 may be connected to the second local network.

Moreover, the method 700 includes commissioning the group of gateway devices, the group of household appliances, and a group of sensors to a single account in a cloud computing network, e.g., as indicated at (706) in FIG. 7. Specifically, the group of gateway devices, which includes the first gateway device 63 and the second gateway device 64, the group of household appliances, which includes the first subgroup of household appliances 59, e.g., first household appliances 10, and the second subgroup of household appliances 60, e.g., second household appliances 11, and a group of sensors, which includes the first sensors 57 and the second sensors 58, may be commissioned to a single account in the cloud 1000. For example, commissioning the group of gateway devices, the group of household appliances, and the group of sensors may be or may include an initial setup of the group of gateway devices, the group of household appliances, and the group of sensors, such as adding the group of gateway devices, the group of household appliances, and the group of sensors to a single user account, e.g., in the cloud 1000, in the remote computing device 1002 or other similar remote device for user account information storage and retrieval. In this respect, the group of household appliances may be monitored and/or controlled by a single remote computing device 1002 or via a single user account across one or more remote computing devices in the cloud 1000. While connected to the single user account, the first sensors 57 may monitor or detect household appliance triggering events of the first subgroup of household appliances 59 and the second sensors 58 may monitor or detect household appliance triggering events of the second subgroup of household appliances 60. Furthermore, while connected to the single user account, the first gateway device 63 may receive data/inputs from the first sensors 57 and/or a list of the household appliances in the first subgroup of household appliances 59 and the second gateway device 64 may receive data/inputs from the second sensors 58 and/or a list of the household appliances in the second subgroup of household appliances 60.

Additionally, the method 700 includes receiving, at a gateway device of the group of gateway devices, an input indicative of a household appliance triggering event from a sensor of the group of sensors, e.g., as indicated at (708) in FIG. 7. Specifically, a gateway device, such as first gateway device 63 and/or second gateway device 64, may receive an input from one or more of first sensors 57 and/or second sensors 58, respectively, indicative of the household appliance triggering event. In some embodiments, the household appliances 10 and 11 may emit/emanate matter and sensors 57 and 58, which may be configured as safety sensors, may detect the emission of such matter from the household appliances 10 and 11 respectively. For example, one or more of first household appliances 10 of first subgroup of household appliances 59 may utilize water within the household appliance, such as a washing machine appliance, a dishwasher, and/or the like. As such, one or more of first sensors 57, which may be water leak sensors and located proximally to such first household appliances 10, may detect the triggering event, e.g., water leaking externally of the first household appliance(s) 10, and transmit the input, e.g., signal or data, to the gateway device, e.g., the first gateway device 63. The transmitted input may be received by the first gateway device 63. In some embodiments, the sensor input described may be received by the gateway device and subsequently transmitted to the remote computing device 1002 of cloud 1000.

Furthermore, the method 700 includes identifying a household appliance of the group of household appliances that is connected to the one local network of the plurality of local networks to which the gateway device is connected, e.g., as indicated at (710) in FIG. 7. Specifically, the gateway device, e.g., first gateway device 63 and/or the second gateway device 64, may identify the household appliance, e.g., one or more of household appliances 10 and/or 11, that is connected to the one local network to which the gateway device is connected. For example, the first sensor 57 may detect the household appliance triggering event and transmit/send the input indicative of the triggering event to the first gateway device 63. The first gateway device 63 may thus be prompted to identify one or more of first household appliances 10, which are connected to the first local network, e.g., via first router 61. In some embodiments, a request may be transmitted by the gateway device, e.g., first gateway device 63 and/or second gateway device 64, within the local network requesting a response from household appliances connected to the local network. For example, the first gateway device 63 may transmit a request, such as an Internet Protocol (IP) multicast query message as part of a Multicast Domain Name System (mDNS) network protocol. The request transmitted by the first gateway device 63 may request a response from the first household appliances 10 of the first subgroup of household appliances 59, which are connected to the first local network. The first household appliances 10, e.g., the controllers 210 thereof, of the first subgroup of household appliances 59 may each receive the request transmitted by the first gateway device 63. Thereafter, each of the first household appliances 10 may transmit a response to the request transmitted by the first gateway device 63 that identifies itself and indicates that it is connected to the first local network. As such, the first gateway device 63 may receive a list of the first household appliances 10 which, as will be described below, may be transmitted to the remote computing device 1002 of cloud 1000. A similar request may be transmitted by the second gateway device 64 and received by the second household appliances 11 of the second subgroup of household appliances 60. Thereafter, each of the second household appliances 11 may transmit a response to the request transmitted by the second gateway device 64 that identifies itself and indicates that it is connected to the second local network.

Additionally, the method 700 includes adjusting an operation of the identified household appliance based on the received input indicative of the household appliance triggering event, e.g., as indicated at (712) in FIG. 7. Specifically, the controller, e.g., controller(s) 210 and/or the remote computing device 1002 of cloud 1000, may adjust the operation of the household appliance(s) 10 and/or 11 based on the input indicative of the household appliance triggering event received at (708). For example, the controller may pause a cycle of a washing machine appliance, e.g., by halting rotation of the basket and/or closing a valve to prevent water from entering the tub. However, it should be appreciated that the operation of the household appliances 10 and/or 11 may be adjusted in any other suitable manner. For example, the controller may activate a display component 104, e.g., a backlit touchscreen, of the household appliances 10 and/or 11 such that light is emitted from the display component 104. In general, adjusting the operation of the household appliance(s) includes causing at least one mechanical or electromechanical component of the appliance(s) to be operated and thereby alter a physical state of the component and/or one or more objects of tangible matter.

In some embodiments, data may be transmitted to the remote computing device 1002 of cloud 1000 by the gateway device, e.g., by the first gateway device 63 and/or the second gateway device 64, indicative of the household appliance identified at (710) and indicative of the household appliance triggering event. As such, the remote computing device 1002 may determine which of the household appliances 10 and/or 11 to control according to the data transmitted by the gateway device. The remote computing device 1002 may transmit/send, and the household appliance(s), e.g., household appliances 10 or 11, may receive, an input to adjust the operation of the identified household appliance. Thereafter, the controller(s) 210 of the household appliances 10 and/or 11 may adjust the operation of the household appliances 10 and/or 11 identified at (710) based on the received input from the remote computing device 1002. As such, the operation of the household appliance, e.g., one of the first household appliances 10, may be remotely adjusted by the remote computing device 1002 transmitting, and the controller(s) 210 of the first household appliance 10 receiving, an input to adjust the operation of the first household appliance 10. Additionally, or alternatively, in some embodiments, the controller 210 may adjust the operation of the household appliance without receiving input or instructions from the remote computing device 1002 to do so. In some embodiments, when a household appliance triggering event is detected for household appliances in less than all of the local networks, e.g., only one of the local networks, the operation of the household appliances that are connected to a local network(s) in which no triggering events were detected are not affected by adjusting the operation of the household appliances in the local network(s) in which triggering events were detected. For example, if only external water leaks were detected on some or all of first household appliances 10 of first subgroup of household appliances 59 but not detected on any of second household appliances 11 of second subgroup of household appliances 60, pausing of the operation of first household appliances 10 does not affect the operation of any of second household appliances 11.

Additionally, in some optional embodiments, the method 700 may include providing a notification to a remote user interface device associated with the household appliance triggering event. For example, the remote computing system associated with cloud 1000 may provide/transmit a notification, which may be displayed, on the remote user interface device. As described herein, the remote user interface device may be any suitable remote user interface device such as a smartphone, tablet, laptop or desktop computer, a user interface panel of a household appliance, e.g., user interface panel 100, and/or the like. In some embodiments, the notification provided may be a physical location of the household appliance connected to the local network. For example, the household appliance may be one of the first household appliances 10 of first subgroup of household appliances 59, which are connected to the first local network. The physical location of the first household appliances 10 may be at a user's primary residence. As such, the notification may indicate that the physical location of the household appliance is the user's primary residence. As such, the user may be notified/alerted of the physical location of the triggering event. Additionally, or alternatively, in some embodiments, the notification provided may be the type of triggering event that occurred, e.g., water leak, smoke detection, user presence detection, and/or the like.

Additionally, or alternatively, in some optional embodiments, the method 700 includes determining a type of household appliance triggering event based on the input received at (708). Specifically, the input received from the first sensor 57 and/or second sensor 58 at (708) may indicate the type of household appliance triggering event that occurred, e.g., user presence detection, water leak, smoke detection, and/or the like. Thereafter, a controller, e.g., controller 210 of household appliances 10 and/or 11 or a remote computing device/server 1002 of cloud 1000 associated with the single account of (706), may determine the type of household appliance triggering event based on the input received at (708).

Additionally, or alternatively, in some optional embodiments, the method 700 includes determining that the household appliance identified at (710) that is connected to the local network is associated with the determined type of household appliance triggering event. Specifically, the controller, e.g., controller 210 of household appliances 10 and/or 11 or a remote computing device/server 1002 of cloud 1000 associated with the single account of (706), may have data stored within its memory of the type of household appliances, e.g., washing machine appliance, dryer appliances, dishwashers, ovens, stovetops, and/or the like, connected to each local network. As such, the controller may determine that the household appliance connected to the local network is associated with the determined type of household appliance triggering event. For example, when the controller determines that the triggering event was a water leak, the controller may determine the household appliances on the respective network, such as the household appliances of the first household appliances 10, that are associated with a water leak, e.g., washing machine, dishwasher, and/or the like. As such, the operation of such household appliance is adjusted by the controller in response to the controller determining that the household appliance is associated with the determined type of household appliance triggering event.

Additionally, in some embodiments, the remote computing device 1002 of cloud 1000 may receive a first input from the gateway device, e.g., first gateway device 63 and/or second gateway device 64, that the gateway device has received an input provided by one or more of the first sensors 57 and/or one or more of the second sensors 58 indicative of the household appliance triggering event. For example, the first gateway device 63 may receive the input from one of first sensors 57 indicative of the household appliance triggering event and transmit the data, the first input, to the remote computing device 1002 of cloud 1000. As such, the remote computing device 1002 may receive the first input from the first gateway device 63. Likewise, the remote computing device 1002 may receive a second input from the gateway device, e.g., first gateway device 63 and/or second gateway device 64, identifying a household appliance from the group of household appliances. For example, the first gateway device 63 may request the response from the first household appliances 10 as described above. Once the first gateway device 63 has received the response(s) from the first household appliances 10 that identifies the first household appliances 10, the first gateway device 63 may transmit/send data, the second input, that identifies the first household appliances 10 to the remote computing device 1002. Thereafter, the remote computing device 1002 may adjust the operation of the first household appliance(s) 10 as described above, e.g., by transmitting/sending an input to the controller(s) 210 of the first household appliance(s) 10, based on the received first input and the received second input from the first gateway device 63.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a group of household appliances, the method comprising:
connecting each household appliance of the group of household appliances to one local network of a plurality of local networks;
connecting each gateway device of a group of gateway devices to one local network of the plurality of local networks;
commissioning the group of gateway devices, the group of household appliances, and a group of sensors to a single account in a cloud computing network;
receiving, at a gateway device of the group of gateway devices, an input indicative of a household appliance triggering event from a sensor of the group of sensors;
identifying a household appliance of the group of household appliances connected to the one local network of the plurality of local networks to which the gateway device is connected; and
adjusting an operation of the identified household appliance based on the received input indicative of the household appliance triggering event.

2. The method of claim 1, further comprising:
providing a notification to a remote user interface device associated with the household appliance triggering event.

3. The method of claim 2, wherein:
the notification provided to the remote user interface device comprises a physical location of the identified household appliance.

4. The method of claim 1, wherein:
the one local network to which the gateway device and the identified household appliance are connected is a first local network;
the plurality of local networks comprises a second local network different from the first local network;
the identified household appliance is a first household appliance;
the group of household appliances further comprises a second household appliance different from the first household appliance, the second household appliance connected to the second local network; and
the second household appliance is not affected by adjusting the operation of the first household appliance.

5. The method of claim 1, wherein the gateway device receives electrical power from an electrical circuit of the identified household appliance.

6. The method of claim 1, wherein the gateway device receives electrical power independently from household appliances.

7. The method of claim 1, further comprising:
determining a type of household appliance triggering event based on the received input indicative of the household appliance triggering event; and
determining that the identified household appliance is associated with the determined type of household appliance triggering event,
wherein, the operation of the identified household appliance is adjusted in response to determining that the identified household appliance is associated with the determined type of household appliance triggering event.

8. The method of claim 1, wherein identifying the household appliance that is connected to the one local network comprises:
transmitting, with the gateway device, a request within the local network requesting a response from appliances connected to the local network;
receiving the transmitted request at the household appliance; and
transmitting, with the household appliance, a response to the gateway device,
wherein, the transmitted response is a response to the received transmitted request identifying the household appliance and indicating that the household appliance is connected to the one local network.

9. The method of claim 8, wherein adjusting the operation of the identified household appliance comprises:
transmitting data to a remote computing device of the cloud computing network, the transmitted data indicative of the identified household appliance and indicative of the household appliance triggering event;
receiving, with the household appliance, an input transmitted from the remote computing device to adjust the operation of the identified household appliance; and
adjusting the operation of the identified household appliance based on the received input to adjust the operation of the identified household appliance.

10. The method of claim 8, wherein the transmitted request comprises a transmitted Internet Protocol (IP) multicast query.

11. The method of claim 1, further comprising connecting the sensor to the gateway device with a wireless, non-WI-FI® connection.

12. The method of claim 1, wherein:
identifying the household appliance that is connected to the one local network comprises transmitting, with the gateway device, a list of household appliances connected to the one local network and the received input of the household appliance triggering event to a remote computing device of the cloud computing network, the list of household appliances including the identified household appliance; and
adjusting the operation of the identified household appliance comprises:
selecting, with the remote computing device, the identified household appliance from the transmitted list of household appliances based on the received input of the household appliance triggering event; and
adjusting the operation of the selected identified household appliance.

13. A system, comprising:
a sensor configured to provide an input indicative of a household appliance triggering event;
a gateway device configured to receive the input provided by the sensor;
a household appliance;
a remote computing device of a cloud computing network, the remote computing device connected to the gateway device and the household appliance, the remote computing device configured to:
receive a first input from the gateway device that the gateway device has received the input provided by the sensor indicative of the household appliance triggering event;
receive a second input from the gateway device identifying the household appliance from a group of household appliances, the household appliance connected to a local network of a plurality of local networks to which the gateway device is connected; and
adjust an operation of the household appliance based on the received first input and the received second input.

14. The system of claim 13, wherein the remote computing device is further configured to:
provide a notification to a remote user interface device associated with the household appliance triggering event.

15. The system of claim 14, wherein:
the notification provided to the remote user interface device comprises a physical location of the household appliance.

16. The system of claim 13, wherein:
the local network is a first local network;
the plurality of local networks includes a second local network different from the first local network;
the household appliance is a first household appliance;
the system further comprises a second household appliance different from the first household appliance, the second household appliance connected to the second local network; and
the second household appliance is not affected by adjusting the operation of the first household appliance.

17. The system of claim 13, wherein the gateway device receives electrical power from an electrical circuit of the household appliance.

18. The system of claim 13, wherein the remote computing device is further configured to:
determine a type of household appliance triggering event based on the input provided by the sensor indicative of the household appliance triggering event;
determine that the household appliance is associated with the determined type of household appliance triggering event; and
adjust the operation of the household appliance in response to determining that the household appliance is associated with the determined type of household appliance triggering event.

19. The system of claim 13, wherein a wireless, non-WI-FI® connection connects the sensor to the gateway device.

20. The system of claim 13, wherein:
receiving the first input from the gateway device comprises receiving an input of the household appliance triggering event;
receiving the second input from the gateway device comprises receiving a list of household appliances connected to the local network, the list of household appliances including the identified household appliance; and
adjusting the operation of the identified household appliance comprises:
selecting the identified household appliance from the received list of household appliances based on the received input of the household appliance triggering event; and
adjusting the operation of the selected identified household appliance.
